(19) United States
(12) Patent Application Publication
(10) Pub. No.: US 2010/0313121 A1
(43) Pub. Date: Dec. 9, 2010

(54) AUTOMATED IDENTIFICATION OF A CUSTOMER'S DOCUMENT BY CUSTOMER SUPPORT

(76) Inventors: Arianne Therese Hinds, Louisville, CO (US); Nenad Rijavec, Longmont, CO (US)

Correspondence Address: DUFT BORNSEN & FISHMAN, LLP, 1526 SPRUCE STREET, SUITE 302, BOULDER, CO, 80302, US

(21) Appl. No.: 12/477,378

(22) Filed: Jun. 3, 2009

(51) Int. Cl. G06F 17/00; G06F 17/30; G06F 15/16

(52) U.S. Cl. 715/273; 709/203; 707/E17.008; 715/810

(57) ABSTRACT

Customer support systems and associated methods are disclosed. A customer wishes to inquire about a particular document individualized for the customer and sends a support request to a customer support system using a client device. The support request includes identification information of the customer and image information based on an image captured by the customer from a copy of the particular document. The customer support system is operable to receive the support request and to select a subset of documents for the customer from a plurality of documents for a plurality of documents based on the identification information. The customer support system is further operable to identify the document from the subset of documents based on the image information, and to initiate a response to the support request using information from the document.

### BACKGROUND

1. Field of the Invention

The invention is related to the field of customer support, and in particular, to identification of a customer's document by customer support.

2. Statement of the Problem

Seeking customer support has long been a frustrating experience for customers. A customer usually has a specific issue or question in mind, but has to wade through a series of telephone prompts and menus before the customer is even able to speak to an appropriate customer support agent. The customer then typically needs to further explain and/or pinpoint the specific issue or question before finally receiving the desired customer support.

For example, suppose the customer suspects that a transaction on a credit card statement is fraudulent. To inquire about the transaction, the customer needs to first reach a customer support agent in the credit card company's fraud department. The customer further needs to communicate enough information to the customer support agent in order to identify the suspected transaction. Finally, appropriate action can then be taken with the suspected transaction.

The advent of transpromo documents has further increased the need to improve customer support. A transpromo document broadly encompasses a transactional document with certain promotional aspects. For example, the transactional document may be a billing statement, and a targeted product offer may be printed on the billing statement. When a customer seeks customer support, it is even more desirable to make the process fast and easy because the customer may be interested in the product offer (which generates new revenue rather than maintaining an existing revenue source).

### SUMMARY

Embodiments provided herein enable automated identification of a customer's document by customer support. Suppose a customer wishes to inquire about a particular document. The customer may use a client device to capture an image from the document and send the image to a customer support system along with identification information of the customer. Using the received information, the customer support system may then automatically identify the document being inquired about by the customer. Thus, when a customer service agent calls the customer, the customer service agent already knows that the customer wishes to inquire about this particular document, and can then use information from this particular document to provide customer support. Such automated identification of the customer's document greatly improves customer support by making the customer support process fast and easy for the customer.

One embodiment comprises a method of supporting a customer. The method includes receiving a support request from a customer. The support request includes identification information of the customer, and image information based on an image captured by the customer from a copy of a target document individualized for the customer. The method also includes selecting a subset of documents for the customer from a plurality of documents for a plurality of customers based on the identification information. Additionally, the method includes identifying the target document from the subset of documents based on the image information. Moreover, the method includes initiating a response to the support request using information from the target document identified from the subset.

Other embodiments may be provided below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram illustrating a customer support system in an exemplary embodiment.

FIG. 2 is a flow chart illustrating a method of supporting a customer in an exemplary embodiment.

FIG. 3 illustrates a copy of a target document individualized for a customer and an image captured by the customer from the copy of the target document in an exemplary embodiment.

FIG. 4 is a flow chart illustrating a method of generating the modified version of the target document in an exemplary embodiment.

FIG. 5 illustrates a modified version of the target document in an exemplary embodiment.

FIG. 6 is another flow chart illustrating a method of generating the modified version of the target document in an exemplary embodiment.

FIG. 7 illustrates another modified version of the target document in an exemplary embodiment.

FIG. 8 illustrates a computer system operable to execute computer readable medium embodying programmed instructions to perform desired functions in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

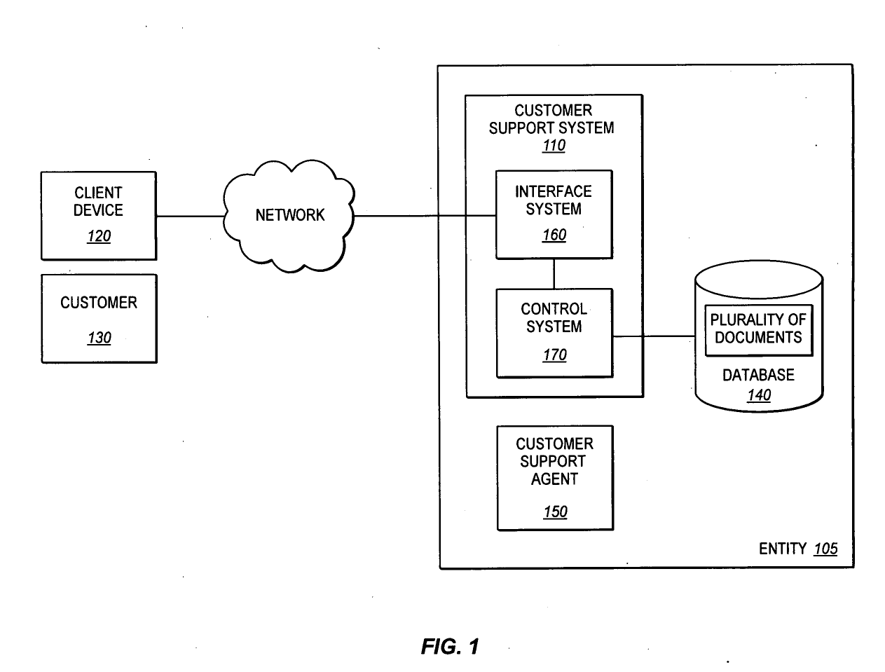

FIG. 1 is a block diagram illustrating a customer support system 110 in an exemplary embodiment. The customer support system 110 is illustrated as being implemented within an entity 105, such as a company, organization, etc. The entity 105 may have sent a copy of a particular document to a customer 130. Meanwhile, the entity 105 may have stored the particular document (for the customer 130) in a database 140 that has a plurality of documents (for a plurality of customers). The entity 105 is adapted to provide customer support to the customer 130 through the customer support system 110.

The database 140 may comprise any database system or repository of documents. In some embodiments, the plurality of documents may be generated from data in another database, as needed. The plurality of documents are each individualized for its respective customer in that each document includes information related to its respective customer as opposed to other customers. For example, a particular document may comprise one of an account statement, a billing statement, an invoice, and a payment instrument (e.g., a check issued to a customer). The particular document may also comprise a transpromo document alluded to above. Typically, each document has been printed and sent to its respective customer, but the delivery method may also be electronic.

After receiving the particular document, the customer 130 may wish to inquire something about the particular document. For example, the customer 130 may wish to inquire about a transaction, an account status, a product offer, and/or even to change the customer's address, among others. The customer 130 uses a client device 120 to capture an image from the document, and sends a support request from the client device 120 to the customer support system 110.

The client device 120 may comprise any device operable to communicate with the customer support system 110. For example, the client device 120 may be capable of operating in a CDMA, GSM, WiMAX, and/or any other suitable networking environment. Additionally, the client device 120 may include an image capture element operable to capture an image. For example, the client device 120 may include a built-in camera. In another embodiment, the image capture capability may also be attained by attaching an external accessory. One example of the client device 120 may be a smartphone or any other similar mobile device.

In some embodiments, the client device 120 may comprise a computer that may communicate with the customer support system 110 over a network including the Internet. The customer 130 may have received the particular document electronically and/or have scanned or otherwise captured an image from the particular document into the computer. The customer 130 may have also used software to select and/or crop a portion of the document to produce the image. The customer 130 may likewise have used software to place a mark or highlight on the document. The customer 130 may then upload or e-mail the image in a support request from the computer to the customer support system 110.

The customer support system 110 may comprise a computer system including a server. The customer support system 110 includes an interface system 160. The interface system 160 may comprise any interface operable to exchange information with the client device 120. For example, the interface system 160 may comprise an Ethernet interface or any other suitable interface for communicating with one or more network elements in a network in which the client device 120 operates. The customer support system 110 also includes a control system 170 in communication with the interface system 160. The control system 170 may comprise any device, server, or function operable to automatically identify the particular document for the customer 130 based on information provided by the customer 130. As noted above, the entity 105 may have stored the document (for the customer 130) in database 140 that has a plurality of documents (for a plurality of customers). The control system 170 is also in communication with the database 140 to identify the particular document from the plurality of documents.

After identifying the particular document for the customer 130, the customer support system 110 may initiate a response to the support request sent by the customer 130. For example, the customer support system 110 may cause a customer support agent 150 to respond to the customer 130. The customer support agent 150 may comprise any machine, software program, and/or human, among others, that can initiate a response to the support request. Types of response may comprise at least one of e-mail, phone call, text messaging, and postal mail.

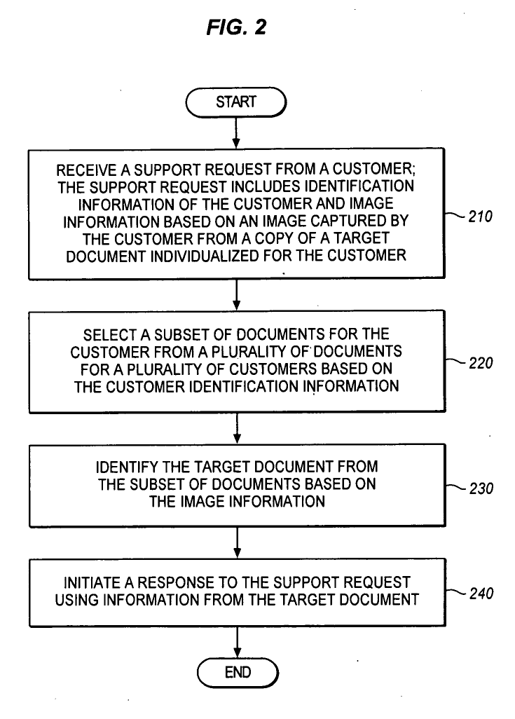

As noted above, the customer 130 may wish to inquire something about the particular document. Also as noted above, the control system 170 is operable to automatically identify the particular document (referred to herein as the “target” document) for the customer 130 based on information provided by the customer 130, and then initiate a response to support the customer 130. FIG. 2 is a flow chart illustrating a method of supporting the customer 130 in an exemplary embodiment. The steps of this method will be described with reference to the customer support system 110 of FIG. 1, although this method may be performed by other customer support systems. The steps of the flow chart in FIG. 2 are not all inclusive and may include other steps not shown.

After the customer 130 sends the support request from the client device 120 to the customer support system 110, the interface system 160 in step 210 receives the support request from the customer 130. The support request includes identification information of the customer 130 and image information based on an image captured by the customer 130 from the copy of the target document (individualized for the customer 130). The image information may comprise a representation of the image captured (e.g., as a JPEG file and/or any other suitable image file) by the customer 130, and/or may comprise a hash and/or other processed data (e.g., as an electronic signature or electronic key) that can be used to identify the target document. The image captured may comprise a full image of the target document or a portion of the target document. It is noted that the customer 130 may have sent the support request to different destinations (e.g., different phone numbers or different e-mail addresses) for the support request to be handled differently. For example, a phone number may be used for reporting frauds, while another phone number may be used for requesting other types of customer support. However, the same customer support system 110 is able to handle support requests sent to different destinations. For example, the customer support system 110 may be able to identify the original destination when the original destination information is updated/stored in the received support request.

The control system 170 then processes the support request to identify the target document from the identification information and the image information. In step 220, the control system 170 selects a subset of documents for the customer 130 from the plurality of documents stored in the database 140 based on the identification information of the customer 130. For example, the control system 170 may supply the identification information of the customer 130 to the database 140 as a search criterion, and receive a subset of documents for the customer 130 back from the database 140. Alternatively or in addition, the control system 170 may also receive the subset of documents as a list of indices so that the control system 170 may later use each index to access its respective document.

In some embodiments, the control system 170 may start to identify the target document from a set of documents that have already been selected before all of the subset of documents for the customer 130 have been fully selected (i.e., the set of documents may be a subset of the subset of documents). In one embodiment, the control system 170 may, as each document for the customer 130 is selected, also identify whether each selected document is the target document. It is noted that in such embodiments, the subset of documents are still selected (i.e., step 220 is still performed), and the target document is still identified from the subset of documents (i.e., step 230 discussed further below is still performed). If the customer support system 110 happens to support only one customer, the subset of documents selected may likely comprise the plurality of documents stored in the database 140.

In step 230, the control system 170 identifies the target document from the subset of documents for the customer 170 based on the image information. For example, the image information may be used as a template, and the control system 170 attempts to match a part of each document to the template. If a match is found in a document, the target document is thus identified. If no match is found in any of the subset of documents, then the control system 170 may cause a message to be sent from the interface 160 to the client device 120 asking the customer 130 to capture a better image and/or to verify identification information of the customer. Alternatively, the control system 170 may nevertheless initiate a response to the customer 130 (but without information from any target document).

Because the subset of documents presents a substantially smaller number of documents that the image information needs to be identified against, the control system 170 is able to more readily and accurately identify the target document. Accordingly, special software does not need to be installed on the client device 120 in order to assist the control system 170 in identifying the target document. However, in some embodiments, special software may be installed on the client device 120 to help the customer 130 to capture the image and/or to generate processed data from the image information to assist the control system 170 in identifying the target document.

In step 240, the control system 170 then initiates a response to the support request from the customer 130 using information from the target document. The control system 170 may initiate the response by generating an electronic and/or a physical message that includes the information from the target document. For example, the control system 170 may create a new task in a work queue (e.g., a queue of help tickets) of the customer support agent 150 and include information from the target document in the new task. The information that is included may comprise the target document, pages(s) or portion(s) of the target document, and/or more specifically a transaction, product offer, and/or another particular item(s) on the target document as will be discussed in greater detail. The customer support agent 150 would handle each task in the work queue, and respond to the support request from the customer 130 as a result. In some embodiments, the customer support agent 150 may be a human who responds to the support request using at least one of e-mail, phone call, text messaging, and postal mail. In other embodiments, the customer support agent 150 may be a machine or software program that performs similar tasks. For example, the target document may be related to a mutual fund, and the control system 170 may cause a prospectus for the mutual fund to be mailed to the customer 130.

The customer 130 may have sent the support request to different destinations (e.g., different phone numbers or different e-mail addresses) for the support request to be handled differently. The particular type of response to the customer 130 may also depend on the original destination. For example, a support request originally sent to a fraud hotline may need to be responded to right away by a phone call, while another support request originally sent to a general customer support phone number may be responded to in a more orderly manner and/or may be responded to based on any of the options detailed below.

One option for responding to the support request may be to access a customer profile in order to identify a response type predefined by the customer 130 in some embodiments. In such embodiments, the customer 130 has already indicated how s/he would like to receive the response. For example, the customer 130 may have already indicated to the customer support system 110 that the customer 130 would like to be called (and if so, at which phone number), be e-mailed, and/or be text messaged (and if so, at which address). Among the wide variety of possibilities, the customer 130 may also indicate that depending on the level of urgency and/or severity of the support request, the customer would like to be called or be responded to in another manner. The customer 130 may also indicate that s/he would like to be called only during certain hours (and optionally at which phone number at which hours). In other situations, the customer 130 may just wish to receive a response in the mail or e-mail. All these possibilities may be captured in a customer profile stored in the customer support system, for example, in the database 140. However, the customer profile may also be stored in the client device 120 of the customer 130 and be accessible to the customer support system 110.

Another option for responding to the customer 130 may be to identify a response type from information included in the support request in some embodiments. The type of response may be entered or selected by the customer 130 as the customer 130 sends out the support request in one embodiment. In another embodiment, the type of response may be retrieved by the client device 120 from a predefined customer profile/preference stored in the client device 120. The predefined customer profile/preference may comprise information similar to the wide variety of possibilities alluded to above with regard to the customer profile that is accessible to the customer support system 110.

Yet another option for responding to the customer may be for the customer support system 110 to send a menu of response types to the customer 130 in some embodiments. For example, the control system 170 may send a menu of response types through the interface 160 to the client device 120. The client device 120 then displays the menu of response types on the client device 120 to allow the customer 130 to make a selection. The customer support system 110 would then receive (from the client device 120) a response type that has been selected by the customer 130. In other embodiments, an automated call may be placed to the customer 130 and then prompt the customer 130 to make a selection. For example, the customer 130 may then choose to speak to the customer service agent 150 and would be connected to the customer service agent 150 in the same phone call. Alternatively, the customer 130 may also choose to be contacted later.

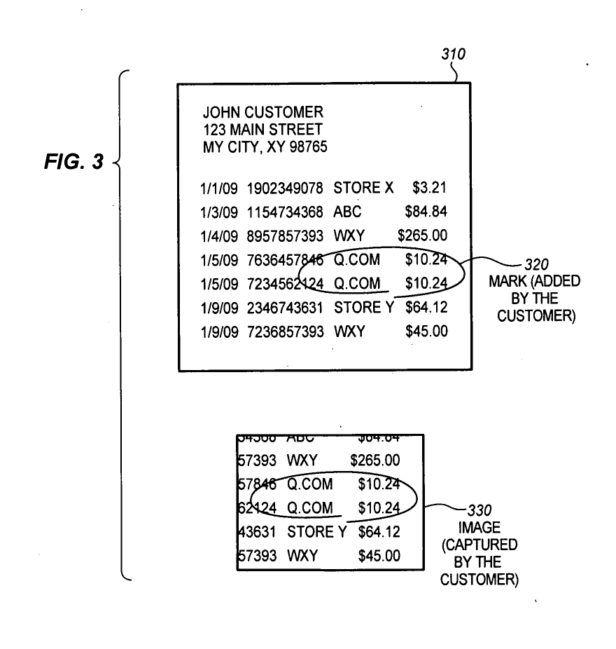

To better pinpoint the transaction, product offer, and/or another particular item(s) on the target document, the customer 130 may have more implicitly captured (and/or selected and/or cropped) the image to correspond with an interested portion of the target document. For example, near the center of the captured image may comprise a product offer, and it may be inferred that the customer 130 is likely interested in the product offer rather than the whole document. Alternatively or in addition, the customer 130 may add a mark to the target document to more explicitly direct attention of the control system 170 and/or the customer support agent 150. The customer 130 may then capture an image of the target document that has the mark, and send the image information in a support request to the customer support system 110. For example, FIG. 3 illustrates a copy 310 of the target document individualized for the customer 130 and an image 330 captured by the customer 130 from the copy 310 of the target document in an exemplary embodiment.

The copy 310 of the target document, which includes the customer's name, address, and transactions, may be a credit card statement that has been mailed to the customer 130. Indeed, the target document may comprise one of an account statement, a billing statement, an invoice, a payment instrument (e.g., a check issued to a customer), and a transpromo document (or any other document individualized for the customer) as noted above. The copy 310 of the target document in this embodiment includes a mark 320 added by the customer 130. For example, the customer 130 may wish to inquire about the transactions near the mark. The mark may comprise one of a circle, a semi-circle, underlining, placing a check mark in a box, drawing an arrow, among others. To inquire about the transactions, the customer 130 captures an image 330, for example, by using a camera function on the client device 120 (which may be a smartphone). Image information of the image 330 captured by the customer 130 is then sent in a support request to the customer support system 110.

In some embodiments, the control system 170 may automatically identify the transaction, product offer, and/or another particular item(s) on the target document pinpointed by the customer. For example, the customer 130 may have captured the image by more implicitly focusing the image on a product offer and/or more explicitly placed a circle around the product offer before capturing the image. The control system 170 may thus be able to automatically identify the product based on the implicit and/or explicit information. The control system 170 may then convey information about the transaction, product offer, and/or another particular item(s) to the customer support agent 150 in an electronic and/or physical message. For example, the control system 170 may cause the customer support agent 150 to mail a brochure related to the product offer to the customer 130.

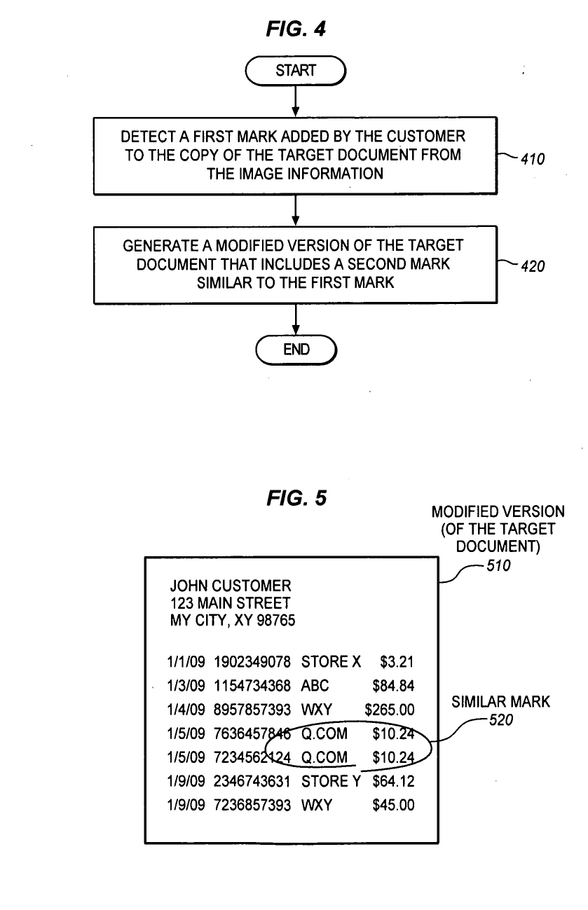

In some instances, the control system 170 may not be able to automatically identify the transaction, product offer, and/or another particular item(s) on the target document pinpointed by the customer. In certain embodiments, the image 330 captured by the customer 130 may simply be presented to the customer support agent 150 and let the customer support agent 150 identify the mark 320 added by the customer 130. Alternatively or in addition, a modified version (which may be an electronic and/or a physical copy) of the target document may be presented to the customer support agent 150. FIG. 4 is a flow chart illustrating a method of generating the modified version of the target document in an exemplary embodiment. As noted above, the control system 170 is able to identify the target document based on the support request. In step 410, the control system 170 further detects a first mark (e.g., 320) added by the customer to the copy 310 of the target document from the image information. For example, the control system 170 may detect the first mark by identifying a number of bits that are “on” in the image information but are “off” in the (original) target document. In step 420, the control system 170 generates a modified version (e.g., 510 of FIG. 5, and may be an electronic and/or a physical copy) of the target document that includes a second mark (e.g., 520 of FIG. 5) similar to the first mark. For example, the bits that are “on” in the image information but are “off” in the (original) target document may be added as the similar mark 520 to the modified version 510 of the target document, which is illustrated in FIG. 5 in an exemplary embodiment.

It is noted that the image 330 may also be superimposed onto and highlighted on the modified version 510 of the target document. For example, a border around an area that corresponds with the image 330 may be added to the modified version 510 of the target document. This may also be the default behavior if no mark is found in the image 330. For example, the customer 130 may have more implicitly captured the image to correspond with an interested portion rather than having more explicitly added a mark.

Beneficially, the customer support agent 150 is provided with the modified version 510 of the target document. The customer support agent 150 is able to identify quickly that the customer 130 is not only inquiring about the credit statement, but most likely the particular transactions under the similar mark 520 even though the customer support agent 150 does not have direct access to the copy 310 of the target document in the customer's possession. If the customer 130 has sent the support request to a fraud hotline, the customer support agent 150 is likely able to take immediate actions to verify the transactions and/or provide additional information without having the customer 130 communicate additional information to the customer support agent 150. In another embodiment, the customer 130 may check a box next to or place a circle around a product or mutual fund offer to receive additional information in the mail. In yet another embodiment, the customer 130 may send the support request to a sales phone number to complete a purchase (the customer support system 110 may already have a payment method preapproved by the customer in a customer profile.)

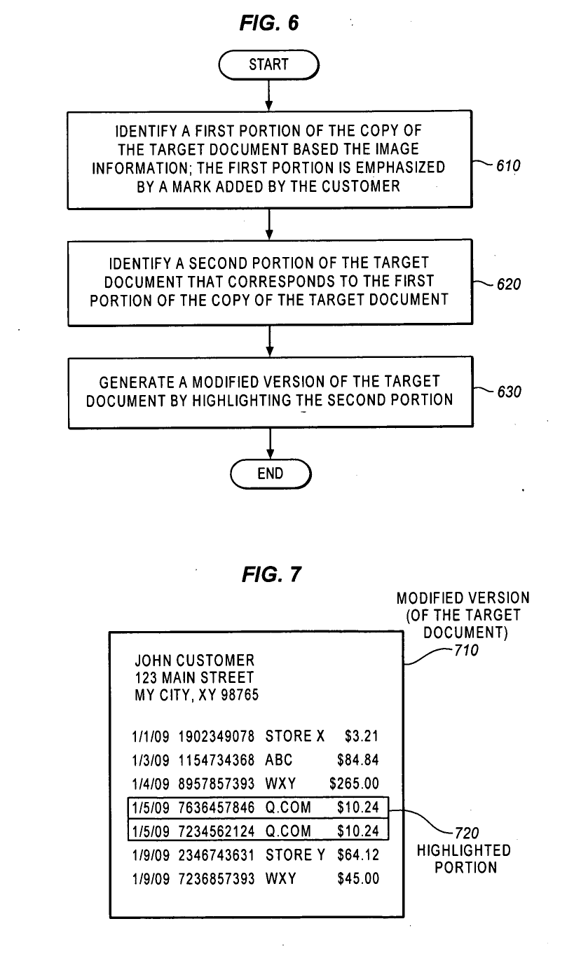

Alternatively or in addition to simply including a mark similar to that added by the customer, the control system 170 may highlight a portion of the target document. This is because simply adding the mark may cover up information on the target document. FIG. 6 is another flow chart illustrating a method of generating another modified version of the target document in an exemplary embodiment. As noted above, the control system 170 is able to identify the target document based on the support request. In step 610, the control system 170 further identifies a first portion of the copy of the target document based the image information, in that the portion is emphasized by a mark (e.g., 320) added by the customer. For example, the control system 170 may identify the portion as having a number of bits that are “on” in the image information but are “off” in the (original) target document.

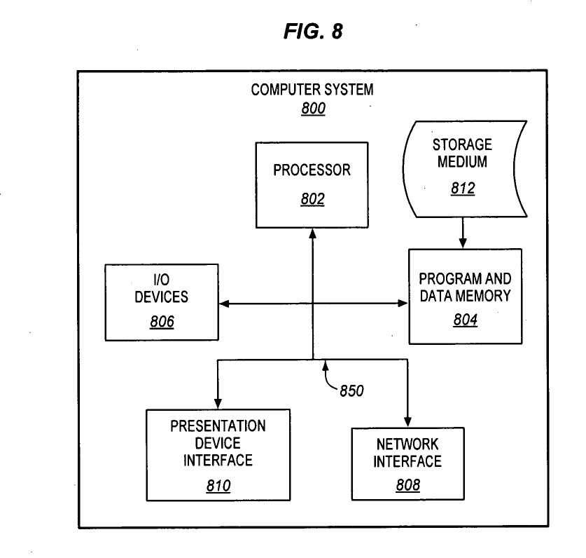

In step 620, the control system 170 identifies a second portion (e.g., 720 of FIG. 7) of the target document, in that the second portion (e.g., 720) corresponds to the first portion. For example, the portion that is emphasized by the mark 320 may be identified by calculating maximum and minimum coordinates in the target document covered by the bits identified from the image information. In step 630, the control system 170 generates a modified version (e.g., 710 of FIG. 7, and may be an electronic and/or a physical copy) of the target document by highlighting the second portion (e.g., 720). For example, the control system 170 may add a box around the text in the second portion (e.g., 720). In other embodiments, the box may be filled with a particular shade or color and the edges of the box may be other than a solid line (e.g., a dashed line or no line). For example, FIG. 7 illustrates another modified version 710 of the target document in an exemplary embodiment in that the control system 170 has highlighted (or otherwise set forth/set off) the portion 720 of the modified version 710 of the target document.

Beneficially, although the customer service agent may be able to discern information from the first modified version 510 of the target document (that has the similar mark 520) not otherwise discernable from the image 330 captured by the customer, the second modified version 710 of the target document (that has the highlighted portion 720) should make discerning information even easier for the customer service agent 150. In some embodiments, both modified versions (510 and 710) of the target document may be provided to the customer service agent.

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 8 is a block diagram depicting a computer system 800 operable to provide features and aspects hereof by executing programmed instructions and accessing data stored on a computer readable storage medium 812.

Furthermore, embodiments of the invention can take the form of a computer program product accessible from a computer-usable or computer-readable medium 812 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A computer system 800 suitable for storing and/or executing program code will include at least one processor 802 coupled directly or indirectly to memory elements 804 through a system bus 850. The memory elements 804 can include local memory employed during actual execution of the program code, bulk storage, and cache memories which provide temporary storage of at least some program code and/or data in order to reduce the number of times code and/or data must be retrieved from bulk storage during execution.

Input/output or I/O devices 806 (including but not limited to keyboards, displays, pointing devices, etc) can be coupled to the system either directly or through intervening I/O control systems. Network adapter interfaces 808 may also be coupled to the system to enable the computer system 800 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 810 may be coupled to the system to interface to one or more presentation device such as printing systems and displays for presentation of presentation data generated by processor 802.

Although specific embodiments were described herein, the scope of the invention is not limited to those specific embodiments. The scope of the invention is defined by the following claims and any equivalents thereof.

We claim:

1. A method of supporting a customer, the method comprising:
receiving a support request from a customer, wherein the support request includes identification information of the customer and image information based on an image captured by the customer from a copy of a target document individualized for the customer;
selecting a subset of documents for the customer from a plurality of documents for a plurality of customers based on the identification information;
identifying the target document from the subset of documents based on the image information; and
initiating a response to the support request using information from the target document.

2. The method of claim 1, further comprising:
detecting a first mark added by the customer to the copy of the target document from the image information; and
generating a modified version of the target document that includes a second mark similar to the first mark.

3. The method of claim 1, further comprising:
identifying a first portion of the copy of the target document based the image information, wherein the first portion is emphasized by a mark added by the customer;
identifying a second portion of the target document that corresponds to the first portion of the copy of the target document; and
generating a modified version of the target document by highlighting the second portion.

4. The method of claim 1, wherein the image information is received from a mobile device of the customer.

5. The method of claim 1, wherein:
the target document includes information related to the customer as opposed to other customers; and
the target document includes one of an account statement, a billing statement, an invoice, and a payment instrument.

6. The method of claim 1, wherein a response type for initiating the response to the support request includes at least one of e-mail, phone call, text messaging, and postal mail.

7. The method of claim 1, wherein initiating the response to the support request includes:
accessing a customer profile to identify a response type predefined by the customer.

8. The method of claim 1, wherein initiating the response to the support request includes:
identifying a response type from information included in the support request.

9. The method of claim 1, further comprising:
sending a menu of response types to the customer; and
receiving a selection from the customer of a desired response type.

10. A customer support system, comprising:
an interface system operable to receive a support request from a client device of a customer, the support request including identification information of the customer and image information based on an image captured by the customer from a copy of a target document individualized for the customer; and
a control system operable to select a subset of documents for the customer from a plurality of documents for a plurality of customers based on the identification information, to identify the target document from the subset of documents based on the image information, and to initiate a response to the support request using information from the target document.

11. The customer support system of claim 10, wherein the control system is further operable to:
detect a first mark added by the customer to the copy of the target document from the image information; and
generate a modified version of the target document that includes a second mark similar to the first mark.

12. The customer support system of claim 10, wherein the control system is further operable to:
identify a first portion of the copy of the target document based the image information, wherein the first portion is emphasized by a mark added by the customer;
identify a second portion of the target document that corresponds to the first portion of the copy of the target document; and
generate a modified version of the target document by highlighting the second portion.

13. The customer support system of claim 10, wherein:
the target document includes information related to the customer as opposed to other customers; and
the target document includes one of an account statement, a billing statement, an invoice, and a payment instrument.

14. The customer support system of claim 10, wherein a response type for initiating the response to the support request includes at least one of e-mail, phone call, text messaging, and postal mail.

15. The customer support system of claim 10, wherein the control system is further operable to:
access a customer profile to identify a response type predefined by the customer.

16. The customer support system of claim 10, wherein the control system is further operable to:
identify a response type from information included in the support request.

17. The customer support system of claim 10, wherein the control system is further operable to:
send a menu of response types to the customer; and
receiving a selection from the customer of a desired response type.

18. A computer readable medium tangibly embodying programmed instructions which, when executed by a computer system, are operable to execute a method of supporting a customer, the method comprising:
receiving a support request from a customer, wherein the support request includes identification information of the customer and image information based on an image captured by the customer from a copy of a target document individualized for the customer;
selecting a subset of documents for the customer from a plurality of documents for a plurality of customers based on the identification information;
identifying the target document from the subset of documents based on the image information; and
initiating a response to the support request using information from the target document.

19. The computer readable medium of claim 18, wherein the method further comprises:
detecting a first mark added by the customer to the copy of the target document from the image information; and
generating a modified version of the target document that includes a second mark similar to the first mark.

20. The computer readable medium of claim 18, wherein the method further comprises:
identifying a first portion of the copy of the target document based the image information, wherein the first portion is emphasized by a mark added by the customer;
identifying a second portion of the target document, wherein the second portion corresponds to the first portion; and
generating a modified version of the target document by highlighting the second portion.
